(19) United States
(12) Patent Application Publication
(10) Pub. No.: US 2024/0351474 A1
(43) Pub. Date: Oct. 24, 2024

(54) ALL-SOLID-STATE BATTERY SYSTEM AND VEHICLE

(71) Applicant: Toyota Jidosha Kabushiki Kaisha, Toyota-shi (JP)

(72) Inventors: Mitsutoshi OTAKI, Susono-shi (JP); Shinji Nakanishi, Mishima-shi (JP); Tetsuya Waseda, Susono-shi (JP); Jun Yoshida, Mishima-shi (JP); Tsubasa Migita, Osaka (JP); Yoshihiro Uchida, Nagakute-shi (JP)

(73) Assignee: Toyota Jidosha Kabushiki Kaisha, Toyota-shi (JP)

(21) Appl. No.: 18/413,263

(22) Filed: Jan. 16, 2024

(30) Foreign Application Priority Data
Apr. 20, 2023 (JP) 2023-069326

(51) Int. Cl. B60L 58/22; B60L 53/62; H01M 10/46; H02J 7/00

(52) U.S. Cl. CPC B60L 58/22; B60L 53/62; H01M 10/46; H02J 7/0014; H02J 7/0048; H02J 7/00712

(57) ABSTRACT

An all-solid-state battery system includes an assembled battery configured by connecting a plurality of cells, and a control device that performs charge control and discharge control of the assembled battery. Each of the plurality of cells is an all-solid-state battery. The control device is configured to perform an equalization process of evenly approximating the amount of stored electricity between the cells in the plateau region in the relationship between the voltage and the amount of stored electricity of the assembled battery in the charge control or the discharge control of the assembled battery.

### CROSS-REFERENCE TO RELATED APPLICATION

This application claims priority to Japanese Patent Application No. 2023-069326 filed on Apr. 20, 2023, incorporated herein by reference in its entirety.

### BACKGROUND

### 1. Technical Field

The present disclosure relates to an all-solid-state battery system and a vehicle including the all-solid-state battery system.

### 2. Description of Related Art

In recent years, research and development of all-solid-state batteries have been advanced. For example, Japanese Unexamined Patent Application Publication No. 2022-133689 (JP 2022-133689 A) discloses a technology for calculating the remaining battery level based on a Li occupancy status in a thickness direction of electrode layers of an all-solid-state battery.

### SUMMARY

With the technology described in JP 2022-133689 A, it is possible to calculate the power storage amount (remaining battery level) of the all-solid-state battery. When a plurality of all-solid-state batteries (cells) is used as an assembled battery by being connected to each other, however, there is a possibility that a variation in the power storage amount occurs between the cells.

The present disclosure has been made to solve the above problem. An object of the present disclosure is to suppress a variation in a power storage amount between cells when a plurality of all-solid-state batteries (cells) is used as an assembled battery by being connected to each other.

An all-solid-state battery system according to an aspect of the present disclosure includes: an assembled battery including a plurality of cells connected to each other; and a control device configured to perform charge control and discharge control on the assembled battery.

Each of the cells is an all-solid-state battery.

The control device is configured to, in the charge control or the discharge control on the assembled battery, perform an equalization process for equalizing power storage amounts of the cells in a plateau region in a relationship between a voltage and a power storage amount of the assembled battery.

According to the present disclosure, it is possible to suppress the variation in the power storage amount between the cells when a plurality of all-solid-state batteries (cells) is used as the assembled battery by being connected to each other.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle according to an embodiment of the present disclosure;

FIG. 2 is a diagram showing components included in the battery pack shown in FIG. 1;

FIG. 3 is a flowchart illustrating a process related to charge control executed by the control device according to the embodiment of the present disclosure;

FIG. 4 is a flow chart illustrating a process related to discharging control executed by a control device according to an embodiment of the present disclosure; and

FIG. 5 is a flowchart illustrating a modification of the charge control illustrated in FIG. 3.

### DETAILED DESCRIPTION OF EMBODIMENTS

Hereinafter, embodiments of the present disclosure will be described in detail with reference to the drawings. It should be noted that the same or corresponding portions in the drawings are designated by the same reference signs and repetitive description will be omitted.

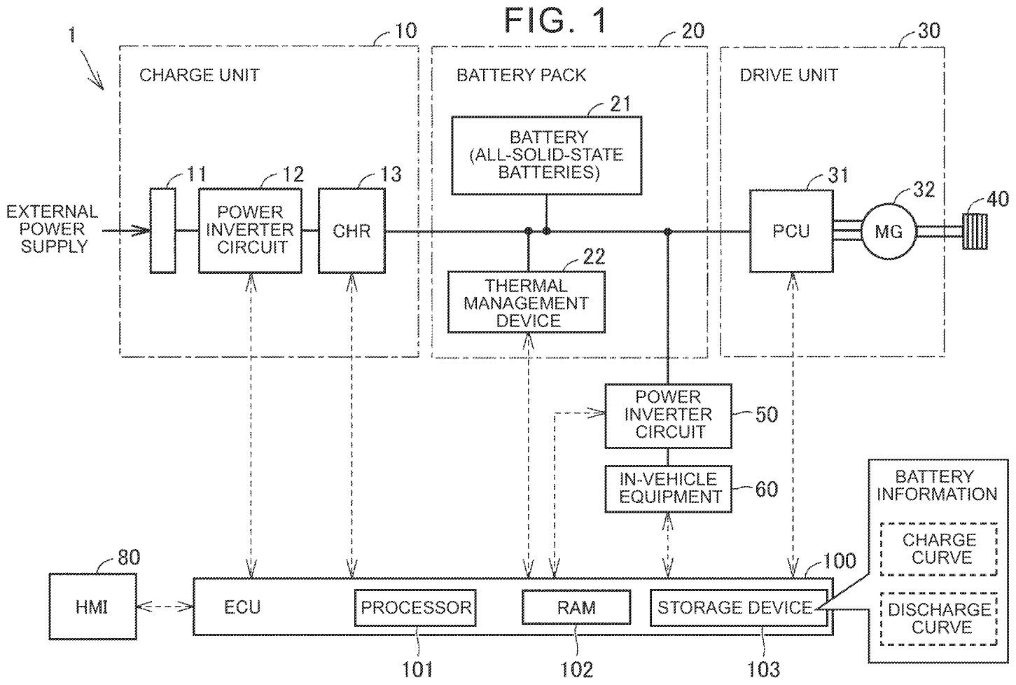

FIG. 1 is a diagram illustrating a schematic configuration of a vehicle according to this embodiment. Referring to FIG. 1, the vehicle 1 is configured to be capable of performing charging (hereinafter, also referred to as “external charging”) using electric power supplied from outside the vehicle (external power supply). Vehicle 1 is a battery electric vehicle (BEV of four wheels). The external charging performed by the vehicles 1 is contact charging (plug-in charging) by electric power supplied from Electric Vehicle Supply Equipment (EVSE). However, the vehicle 1 may be another electrified vehicle (xEV such as plug-in hybrid electric vehicle). The number of wheels is also arbitrary, and may be three wheels or five wheels or more. The external charging may be contactless charging.

The vehicle 1 includes a charge unit 10, a battery pack 20, a drive unit 30, drive wheels 40, a power conversion circuit 50, an in-vehicle device 60, and an Electronic Control Unit (ECU) 100. The charge unit 10 includes an inlet 11, a power conversion circuit 12, and a charging relay (CHR) 13. The power conversion circuit 12 includes, for example, at least one of a DC/DC converter and an inverter. The battery pack 20 includes a battery 21 and a thermal management device 22 that adjusts the temperature of the battery 21. The thermal management device 22 includes, for example, at least one of an electric heater and a cooling device. The drive unit 30 includes a Power Control Unit (PCU)31 and a motor generator (MG) 32). PCU 31 drives MG 32 using the electric power supplied from the battery 21. MG 32 rotates the drive wheels 40. In this way, the vehicle 1 is configured to be electrically driven. The battery 21 also supplies electric power to the in-vehicle device 60. The in-vehicle device 60 includes an air conditioner that performs air conditioning inside the vehicle 1. The electric power from the battery 21 is supplied to the in-vehicle device 60 via the power conversion circuit 50. The power conversion circuit 50 includes, for example, at least one of a DC/DC converter and an inverter. ECU 100 controls the charge unit 10, the battery pack 20, the drive unit 30, and the power conversion circuit 50.

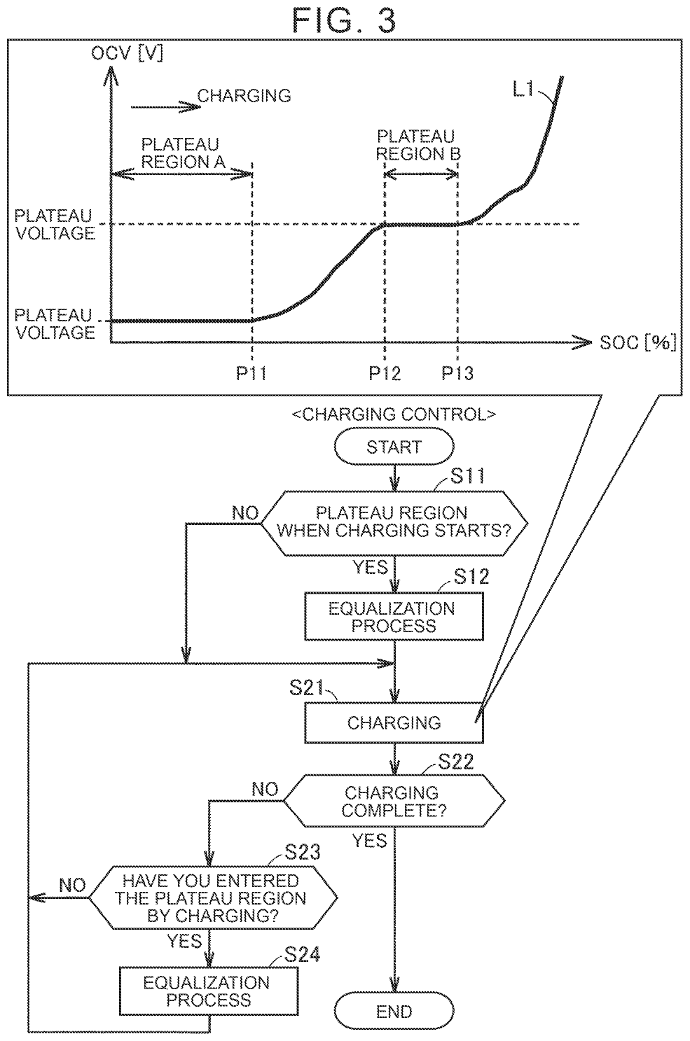

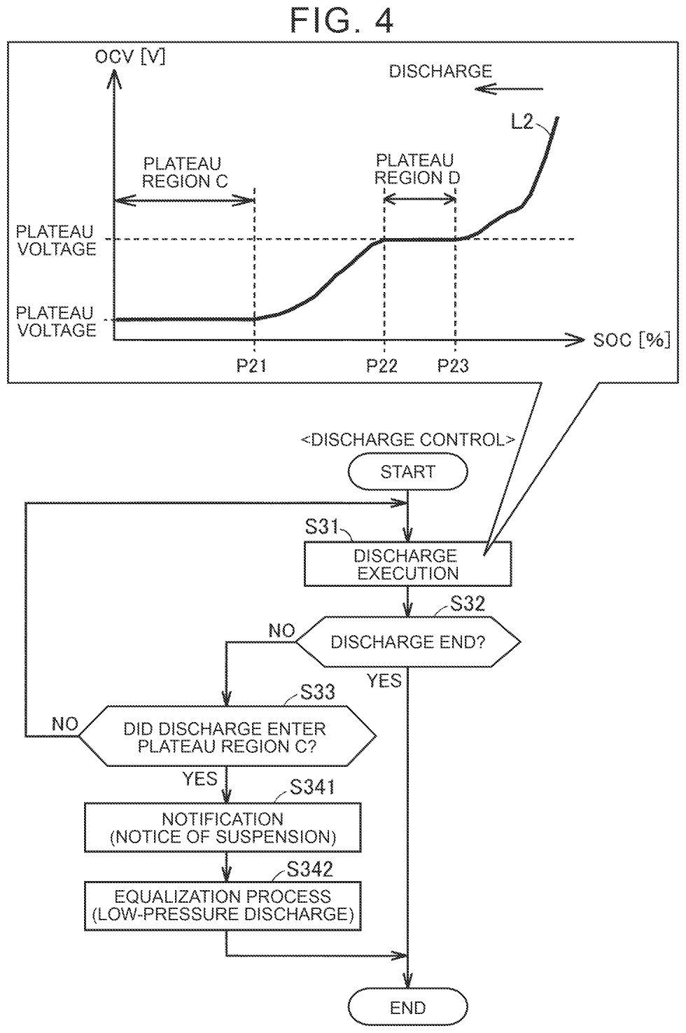

ECU 100 includes a processor 101, a Random Access Memory (RAM)102, and a storage device 103. The processor 101 may be, for example, a Central Processing Unit (CPU). The storage device 103 is configured to store stored information. In addition to the program, the storage device 103 stores information (for example, a map, a mathematical expression, and various parameters) used in the program. In this embodiment, the processor 101 executes a program stored in the storage device 103 to execute various kinds of control (for example, control illustrated in FIGS. 3 and 4 described later) in ECU 100. However, various kinds of control in ECU 100 may be executed by hardware (electronic circuitry) instead of software. ECU 100 may include any number of processors, and may include a plurality of processors.

Human Machine Interface (HMI) 80 is located inside or outside the vehicle 1. ECU 100 is configured to be able to communicate with Human Machine Interface (HMI) 80. HMI 80 includes an inputting device and a notification device (for example, a displaying device and a speaker). HMI 80 may be a terminal (for example, a navigation system) mounted on the vehicle 1. HMI 80 may also be a mobile terminal (e.g., a smart phone or a wearable device) that is portable by a user.

The storage device 103 stores battery information related to the battery 21. The battery information includes data indicating a change in the voltage of the battery 21 due to an increase in the amount of electric power stored in the battery 21 during charging (hereinafter, referred to as a “charging curve”), and data indicating a change in the voltage of the battery 21 due to a decrease in the amount of electric power stored in the battery 21 during discharging (hereinafter, referred to as a “discharging curve”). The charging curve and the discharging curve are measured in advance and stored in the storage device 103. Each of the charging curve and the discharging curve indicates a relationship between the voltage and the amount of stored electricity of the battery 21. The “voltage” in the respective curves is, for example, an open circuit voltage (OCV). The storage capacity of the battery 21 is represented by, for example, State Of Charge (SOC). SOC represents a ratio of the present storage amount to the storage amount in a fully charged state, for example, from 0 to 100%. ECU 100 may sequentially update the charge curve and the discharge curve in the storage device 103 using data (e.g., voltage and SOC) actually measured under the control of the battery 21 (FIGS. 3 and 4), which will be described later.

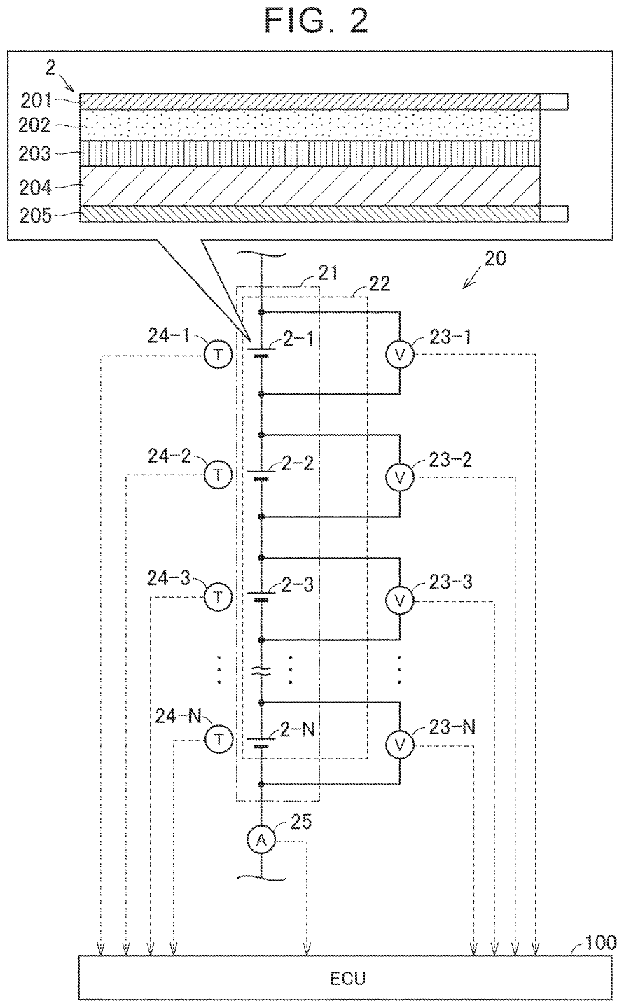

Although not shown in FIG. 1, the battery pack 20 is also equipped with a Battery Management System (BMS for monitoring the status of the battery 21. BMS includes various sensors for detecting the status of the battery 21. Hereinafter, the internal configuration of the battery pack 20 will be described with reference to FIG. 2.

FIG. 2 is a diagram illustrating components included in the battery pack 20. Referring to FIG. 2, the battery 21 is an assembled battery configured by connecting 2-N from N cells 2-1. N is a natural number of 2 or more, and may be 2 or more and less than 100 or 100 or more. The cells 2-1 to 2-N are connected in series. However, the connection mode of the cells in the assembled battery is not limited to series, and may include parallel connection. In this embodiment, since the cells 2-1 to 2-N shown in FIG. 2 have the same configuration, they are hereinafter referred to as “cells 2” when they are not distinguished from each other. The cell 2 is an all-solid-state secondary battery constituting an assembled battery.

The cell 2 includes a positive electrode current collector 201, a positive electrode layer 202, an electrolyte layer 203, a negative electrode layer 204, and a negative electrode current collector 205. The positive electrode current collector 201 is configured to collect the positive electrode layer 202. Examples of the material of the positive electrode current collector 201 include Steel Use Stainless (SUS), aluminum, nickel, iron, titanium, and carbon. The negative electrode current collector 205 is configured to collect the negative electrode layer 204. Examples of the negative electrode current collector 205 include SUS, copper, nickel, and carbon. The shape of the cell 2 may be, for example, a cuboid (square), a laminate, a cylindrical, a button, a coin, or a flat.

In the cell 2, which is an all-solid-state battery, the electrolyte layer 203 includes a solid electrolyte. The electrolyte layer 203 is located between the positive electrode layer 202 and the negative electrode layer 204. The thickness of the electrolyte layer 203 is, for example, 0.1 μm or more and 1000 μm or less. Examples of solid electrolytes include inorganic solid electrolytes (e.g., sulfide solid electrolytes, object solid electrolytes, nitride solid electrolytes, halide solid electrolytes, etc.), and organic-polyelectrolytes (e.g., poly-electrolytes). Exemplary sulfide solid electrolytes include solid electrolytes that contain elemental Li, elemental X (where X is at least one of P, As, Sb, Si, Ge, Sn, B, Al, Ga, In), and elemental S. The sulfide solid electrolyte may further contain at least one of an O element and a halogen element. The sulfide solid electrolyte may be glass (amorphous) or glass ceramic. Examples of the sulfide solid electrolyte include Li₂S—P₂S₅, LiI—Li₂S—P₂S₅, LiI—LiBr—Li₂S—P₂S₅, Li₂S—SiS₂, Li₂S—GeS₂, and Li₂S—P₂S₅—GeS₂.

The positive electrode layer 202 is a layer containing at least a positive electrode active material. The thickness of the positive electrode layer 202 is, for example, 0.1 μm or more and 1000 μm or less. The positive electrode layer 202 may contain at least one of an electrolyte, a conductive material (carbon material, metal particles, conductive polymer, and the like), and a binder, if necessary.

The positive electrode active material is, for example, an oxide active material. Examples of the oxide active material include rock-salt layered active materials (LiCoO₂, LiMnO₂, LiNiO₂, LiVO₂, LiNim₃Co_{1/3}Mn_{1/3}O₂, etc.), spinel-type active materials (LiMn₂O₄, Li₄Ti₅Oi₂, Li(Ni_{0.5}Mn_{1.5})O₄, etc.), and olivine-type active materials (LiFePO₄, LiMnPO₄, LiNiPO₄, LiCoPO₄, etc.). Coating layers including a Li ion-conductive oxide may be formed on the oxide active material. Such a coating layer can suppress the reaction between the oxide active material and the solid electrolyte (particularly, the sulfide solid electrolyte). Exemplary Li ion-conducting oxides include LiNbO₃. The thickness of the coating layers is, for example, greater than or equal to 1 nm and less than or equal to 30 nm. However, the positive electrode active material is not limited to the oxide active material. For example, Li₂S may be used as the positive electrode active material.

The negative electrode layer 204 is a layer containing at least a negative electrode active material. The thickness of the negative electrode layer 204 is, for example, 0.1 μm or more and 1000 μm or less. The proportion of the negative electrode active material in the negative electrode layer 204 is, for example, 20 wt % or more and 80 wt % or less. The negative electrode layer 204 may contain at least one of an electrolyte, a conductive material (a carbon material, a metal particle, a conductive polymer, and the like), and a binder, if necessary.

In this embodiment, the negative electrode active material has a crystalline phase of the silicon clathrate II type. For example, a Na source (e.g., metal Na dispersions in which particles of metal Na, NaH, or metal Na are dispersed in oils) and a Si source (e.g., porous Si with voids inside the primary particles) are reacted to obtain a Na—Si alloy. Thereafter, Na—Si alloy can be heated to reduce Na content in Na—Si alloy, thereby producing a crystalline phase of the silicon clathrate II type. In the crystalline phase of the silicon clathrate II type, a polyhedron (cage) including a pentagon or a hexagon is formed by a plurality of Si elements. The polyhedron has a space therein that can contain metallic ions, such as Li ions. The negative electrode active material may have minute voids having pore diameters of 100 nm or smaller. The porosity may be, for example, 4% or more and 40% or less. By inserting metal ions into this space, volume change due to charge and discharge can be suppressed. A typical Si has a diamond-type crystalline phase.

Note that the structure and the material of the cell 2 are not limited to those described above, and can be changed as appropriate. The battery pack 20 may further include a restraining tool that applies a restraining pressure along the stacking direction of 2-N from the cell 2-1. A constraining pressure (e.g., a constraining pressure greater than or equal to 0.1 MPa and less than or equal to 100 MPa) may be applied to form a good ion-conduction path and an electron-conduction path.

The battery pack 20 further includes a current sensor 25 for detecting a current flowing through the battery 21 (assembled battery), and voltage sensors 23-1 to 23-N and temperature sensors 24-1 to 24-N corresponding to the cells 2-1 to 2-N, respectively. Detected by the sensors are inputted into ECU 100. The sensors function as BMS. ECU 100 can acquire the current of the battery 21 and the voltage/temperature of each cell of the battery 21 based on the signals from the respective sensors. In addition, ECU 100 can calculate SOC for each cell from the detected data by the respective sensors. With respect to the parameters (e.g., voltage, temperature, and SOC) detected for each cell in battery 21, a representative value (e.g., a mean value or a median value) of the values detected for each cell may be regarded as a detected value of the battery 21. The configuration of BMS can be changed as appropriate. For example, the number of each of the current sensor and the temperature sensor may be not one in one cell but one in a plurality of cells.

Incidentally, when a plurality of all-solid-state batteries (cells) are connected to each other and used as an assembled battery, variations in the amount of electricity storage between the cells tend to occur. Therefore, as described below, ECU 100 according to this embodiment suppresses variations in the amount of electricity storage between cells by executing the charge control shown in FIG. 3 and the discharge control shown in FIG. 4.

FIG. 3 is a flow chart illustrating a process related to charge control executed by ECU 100. Each step in the flowchart is simply referred to as “S”. The process illustrated in this flowchart is started, for example, when the start condition of the plug-in charging is satisfied. Specifically, when the connector of the charging cable of EVSE (external power supply) is connected to the inlet 11 of the vehicle 1, the process flow (S24 from S11, S12 and S21) described below may be started while the start condition of the plug-in charging is satisfied.

Referring to FIG. 3, in S11, ECU 100 acquires SOC of the present battery 21 and determines whether the obtained SOC belongs to the plateau region of the charge-curve L1. Specifically, ECU 100 reads the charge curve L1 from the storage device 103 and recognizes the plateau region of the charge curve L1. A plateau region is a region in which a charge curve or a discharge curve becomes flat. In the plateau region, the amount of change in voltage (slope of the curve) with respect to the amount of change in the amount of stored electricity is smaller than the reference amount of change. The plateau voltage is the battery voltage in the plateau region.

In the charge-curve L1 shown in FIG. 3, each of the first SOC range (plateau region A) from 0% to the value P11 and the second SOC range (plateau region B) from the value P12 to the value P13 corresponds to the plateau region. In this embodiment, P11, P12, P13 are 30%, 60%, and 80%, respectively, and first SOC range and second SOC range are 30% and 20%, respectively. However, each of P11, P12, P13 is not limited to the above, and may vary depending on the properties of the cells (all-solid-state batteries) employed. The range of the first SOC is preferably 5% or more, and more preferably 15% or more. Each of the cells 2-1 to 2-N constituting the battery 21 according to this embodiment is an all-solid-state battery including an electrode layer (specifically, a negative electrode layer) including a silicon clathrate. These all-solid-state batteries tend to have distinct plateau regions in the low SOC regions in each of the charge and discharge curves. More specifically, all-solid-state batteries tend to have plateau regions in at least a portion of SOC range from 0% to 30%.

In this embodiment, when SOC of the battery 21 when the plug-in charge is started falls within one of the first SOC range (0 to 30%) and the second SOC range (60 to 80%), it is determined that S11 is YES. If SOC does not belong to any of the first and second SOC ranges, it is determined to be NO in S11. As a method of measuring SOC, for example, a known method such as a current integration method can be employed.

If YES is determined in S11, ECU 100 performs the equalization process of the battery 21 in a subsequent 512. The equalization process is a process of equalizing the amount of electricity storage between the cells. In this embodiment, ECU 100 controls the charge unit 10 to match SOC of each of the cells 2-1 to 2-N (FIG. 2) in S12. Specifically, ECU 100 performs charge control (external charge) of the battery 21 at a voltage lower than a normal charge (S21) described later (hereinafter, referred to as “first equalization voltage”) in the plateau region. The first equalization voltage may be a voltage lower than a reference voltage (S21), which will be described later, and may be less than or equal to one half of the reference voltage. ECU 100 may be voltage-adjusted (step-down) by the power conversion circuit 12. With respect to the battery 21, the voltage variation between the cells and the potential variation inside the cells (e.g., the potential variation caused by the reaction unevenness) are reduced by the equalization process. In an all-solid-state battery that does not include an electrolyte solution, it is difficult to form an ion conduction path between the solid electrolytes in the thickness direction, and the resistance associated with the movement of the ions in the thickness direction is high. Therefore, reaction unevenness is likely to occur.

When the equalization process is completed, the process proceeds to S21. ECU 100 may determine whether or not the equalization process has been completed based on the status (e.g., SOC) of the cells of the battery 21. Alternatively, ECU 100 may determine that the equalization process has been completed when a predetermined period of time has elapsed since the equalization process was started. If SOC of the battery 21 exits the plateau region during the equalization process, ECU 100 may stop the equalization process and proceed to S21. Further, when it is determined that S11 is NO, the process proceeds to S21.

In S21, ECU 100 performs external charging (plug-in charging) of the battery 21 at a predetermined reference voltage. The reference voltage may be determined according to the specifications (for example, the rated voltage) of EVSE connected to the vehicles 1. ECU 100 controls the charge unit 10 so that the battery 21 is charged by the electric power supplied from EVSE.

Subsequently, in S22, ECU 100 determines whether or not to terminate the charging based on whether or not the charging termination condition is satisfied. The charge termination condition is satisfied, for example, when SOC of the battery 21 reaches the target value. The target may be automatically set by ECU 100 or EVSE. Alternatively, the target value may be set by the user. The target value may be 100% (SOC value indicating full charge). The charging end condition is also satisfied when the charging cable is detached from the inlet 11. Note that the charging end condition can be changed as appropriate. For example, the charge termination condition may be satisfied when a predetermined period of time has elapsed since the external charge (S21) is started. In addition, the charging end condition may be satisfied in response to an instruction to stop charging from the user.

When the charge-end condition is not satisfied (NO in S22), the process proceeds to S23. In S23, ECU 100 determines whether or not SOC of the battery 21 has entered the plateau region of the charge curve L1 by the charging (S21). In this embodiment, when SOC of the battery 21 increases due to the above-described charge and reaches the value P12, it is determined that S23 is YES, and the process proceeds to S24. In S24, ECU 100 performs the equalization process (for example, the low-voltage charge described above) of the battery 21. S24 equalization process may be the same as or different from S12 equalization process. When S24 equalization process is completed, the process returns to S21. Also, when it is determined that S23 is NO, the process returns to S21. When S24 equalization process is completed, it is determined as NO in S23.

While both S22 and S23 are determined to be NO, the external charge (S21) of the battery 21 at the reference voltage is continuously performed. When the charge termination condition is satisfied (YES in S22), the process shown in FIG. 3 ends.

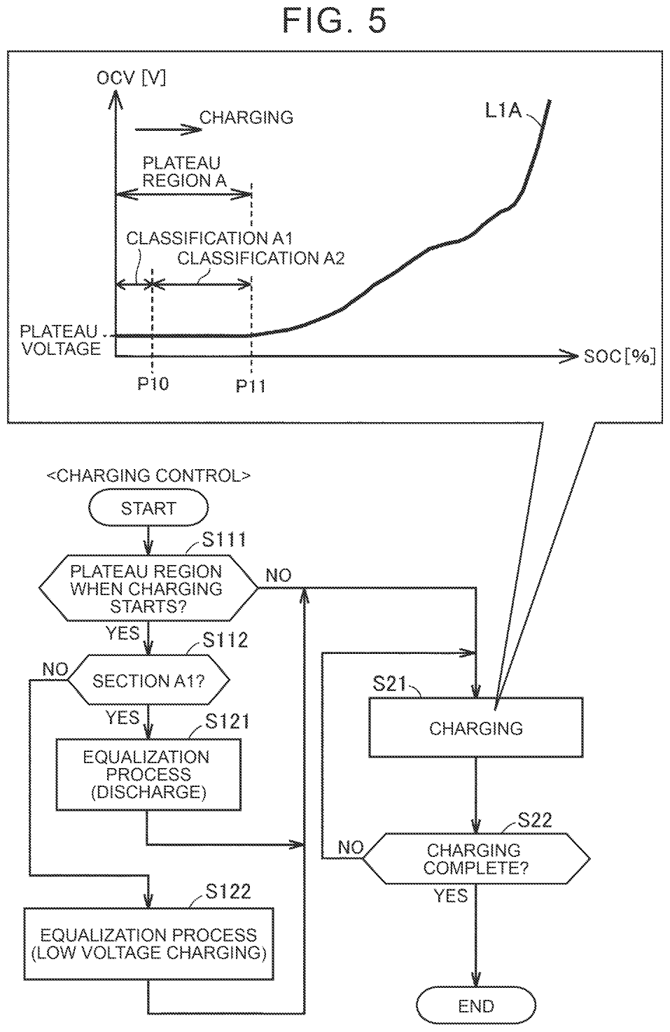

The equalization process is not limited to the low-voltage charging described above. The equalization process in each of S12 and S24 may be, for example, a process of stopping the charge of the battery 21. In the plateau region, the voltage of each cell constituting the battery 21 approaches the plateau voltage by stopping the charging. For example, when SOC of the battery 21 belongs to the plateau region and the condition for starting the plug-in charge is satisfied (YES in S11) after the vehicle 1 finishes running (electric running) using the electric power of the battery 21, ECU 100 may wait in the plateau region without charging or discharging the battery 21 in S12. Thereafter, the plug-in charge (S21) of the battery 21 may be started. In addition, in the charge control of the battery 21, ECU 100 may stop the charge of the battery 21 as the equalization process when the storage capacity of the battery 21 belongs to the plateau region, and may perform the charge of the battery 21 after the equalization process ends. Specifically, when the charge control is started, SOC of the battery 21 does not belong to the plateau region (NO in S11), and when SOC of the battery 21 is increased by the plug-in charge (S21) so as to belong to the plateau region (YES in S23), ECU 100 may stop the charge of the battery 21 in S24. After the equalization process is completed, ECU 100 may resume the plug-in charge (S21) of the battery 21. Further, the equalization process may be discharging (see S121 of FIG. 5) described later.

FIG. 4 is a flow chart illustrating a process related to discharging control executed by ECU 100. The process illustrated in this flowchart is started, for example, when the condition for starting the discharge of the battery 21 is satisfied in the vehicle 1 that is stopped. Specifically, in the stopped vehicle 1, when SOC of the battery 21 is higher than the lower limit value (for example, a value P21 to be described later) and ON operation (for example, the operation request) of the in-vehicle device 60 (for example, the air conditioner) is performed by the user, the discharging start condition of the battery 21 may be satisfied, and the following process flow (S33 and S341, S342 from S31) may be started.

Referring to FIG. 4, in S31, ECU 100 discharges the battery 21. Specifically, ECU 100 controls the power conversion circuit 50 so that electric power for operating the in-vehicle device 60 is supplied from the battery 21 to the in-vehicle device 60. That is, ECU 100 executes the discharging control of the battery 21 at the driving voltage of the in-vehicle device 60 in S31. Hereinafter, the in-vehicle device 60 that is supplied with electric power from the battery 21 is referred to as a “target device”.

Subsequently, in S32, ECU 100 determines whether or not to terminate the discharge based on whether or not the discharge termination condition is satisfied. The discharge-end condition is satisfied, for example, when OFF operation (stop-request) of the target device is performed by the user. The discharge end condition is also satisfied when the vehicle 1 starts traveling. Note that the discharge end condition can be changed as appropriate.

When the discharge-end condition is not satisfied (NO in S32), the process proceeds to S33. In S33, ECU 100 determines whether or not SOC of the battery 21 has entered the plateau region (in this embodiment, the plateau region C shown below) located on the lowest SOC of the plateau region of the discharge curve L2 by S31.

Specifically, ECU 100 reads the discharge curve L2 from the storage device 103 and recognizes the plateau region of the discharge curve L2. In the discharge-curve L2 shown in FIG. 4, each of the third SOC range (plateau region C) from 0% to the value P21 and the fourth SOC range (plateau region D) from the value P22 to the value P23 corresponds to the plateau region. In this embodiment, P21, P22, P23 are 30%, 55%, and 75%, respectively. Third range and fourth SOC range are 30% and 20%, respectively. However, each of the value P21, P22, P23 is not limited to the above values, and may vary depending on the properties of the cells (all-solid-state batteries) to be adopted. The range of the third SOC is preferably 5% or more, and more preferably 15% or more.

When SOC of the battery 21 is higher than P21, it is determined as NO in S33. In this embodiment, while both S32 and S33 are determined to be NO, S31 from the battery 21 to the target device is continuously performed. Then, when SOC of the battery 21 drops due to the discharging (S31) and reaches the value P21, it is determined as YES in S33, and the process proceeds to S341.

In S341, ECU 100 announces to the user that discharging is stopped. Specifically, ECU 100 controls HMI 80 so as to notify the user of, for example, stoppage of the target device. HMI 80 may provide the notification in a displayed or audible manner. Subsequently, ECU 100 performs the equalization process of the battery 21 in S342. Specifically, ECU 100 performs discharging control of the battery 21 at a voltage lower than the driving voltage (S31) of the in-vehicle device 60 (hereinafter, referred to as “second equalization voltage”) in the plateau region C. As a result, the power supply from the battery 21 to the target device is stopped. The second equalization voltage is a voltage lower than the discharging voltage of S31. In S342, low-voltage discharging of the battery 21 is performed. ECU 100 may adjust (step down) the voltage by, for example, the power conversion circuit 50. The discharged electric power may be consumed by an electric power load (not shown) included in the in-vehicle device 60 or may be stored in an auxiliary battery (not shown). The equalization process of S342 reduces the inter-cell voltage variation and the intra-cell potential variation with respect to the battery 21. In the low SOC plateau region (plateau region close to overdischarge), relaxation (equalization) of these variations is particularly promoted.

When S342 equalization process is completed, the process illustrated in FIG. 4 ends. When the discharge-end condition is satisfied (YES in S32), the process illustrated in FIG. 4 ends. In the discharge control illustrated in FIG. 4, the equalization process of the battery 21 is not executed in the plateau region D so as not to excessively reduce the convenience of the user. However, the present disclosure is not limited thereto, and ECU 100 may perform the equalization process of the battery 21 not only in the plateau region C but also in the plateau region D. Further, the discharge control of the battery 21 is not limited to the discharge control for operating the in-vehicle device 60. The discharge control of the battery 21 may be a discharge control for supplying power to the outside of the vehicle.

As described above, the vehicle 1 according to this embodiment includes an all-solid-state battery system. The all-solid-state battery system includes a battery 21 and an ECU 100 (control device) that performs charge-control and discharge-control of the battery 21. The battery 21 is an assembled battery configured by connecting a plurality of cells. Each of the plurality of cells is an all-solid-state battery. ECU 100 is configured to perform an equalization process (S12, S24 of FIG. 3 and S342 of FIG. 4) for evenly approximating the amount of stored electricity between cells in a plateau region (flat area) in relation to the voltage and the amount of stored electricity of the battery 21 in charge control or discharge control of the battery 21. In the plateau region, the voltage of each cell (all-solid-state battery) constituting the assembled battery is likely to approach the plateau voltage. Therefore, in the plateau region, the equalization of the amount of electricity storage between the cells is promoted. According to the above configuration, when a plurality of all-solid-state batteries (cells) are connected to each other and used as an assembled battery, variations in the amount of electricity storage between the cells are suppressed.

Each of the charging curve and the discharging curve of the battery 21 according to the above-described embodiment has a plurality of spaced-apart plateau regions. However, the present disclosure is not limited thereto, and each of the charge curve and the discharge curve may have only one plateau region. For example, the charging curve of the battery 21 may have the plateau region A shown in FIG. 3 as the only plateau region. With respect to the battery 21 as well, it is possible to suppress variations in the amount of electricity storage between the cells by the charge control illustrated in FIG. 3. Further, the discharge curve of the battery 21 may have the plateau region C shown in FIG. 4 as the only plateau region. Also in such a battery 21, it is possible to suppress the variation in the amount of electricity storage between the cells by the discharge control shown in FIG. 4.

The processing flows shown in FIGS. 3 and 4 can be changed as appropriate. For example, the order of processing may be changed, or unnecessary steps may be omitted, depending on the purpose. Further, the content of any of the processes may be changed. For example, instead of the charge control illustrated in FIG. 3, ECU 100 may execute the charge control illustrated in FIG. 5 described below.

FIG. 5 is a flowchart illustrating a modification of the charge control illustrated in FIG. 3. The battery 21 (all-solid-state battery) according to this modification has a property represented by a charge-curve L1A. The charge-curve L1A has a plateau region A as the only plateau region. The plateau region A in FIG. 5 is the same as the plateau region A shown in FIG. 3. However, ECU 100 recognizes the plateau region A by dividing it into a plurality of sections (more specifically, the section A1 and A2). The plateau region A of the charge curve L1A shown in FIG. 5 includes a first section from 0% to the value P10 (section A1) and a second section from the value P10 to the value P11 (section A2). The values P10 and P11 are stored in advance in the storage device 103 together with the charge curve L1A. The value P10 is smaller than the value P11. The value P10 is an SOC value in the vicinity of 0%, for example, an SOC value selected from a range of 0% to 15% inclusive.

Referring to FIG. 5, in S111, ECU 100 acquires SOC of the present battery 21 and determines whether the obtained SOC belongs to the plateau region A (0% to P11) of the charge-curve L1A. Then, when SOC of the battery 21 belongs to the plateau region A of the charge curve L1A (YES in S111), ECU 100 determines whether or not SOC of the battery 21 belongs to the section A1 (0% to P10) in the subsequent S112. When SOC of the battery 21 belongs to the section A1 (YES in S112), ECU 100 executes the first equalization process of the battery 21 in S121. If SOC of the battery 21 belongs to a section (section A2) other than the section A1 (NO in S112), ECU 100 executes the second equalization process of the battery 21 in S122.

The first equalization process is discharge of the battery 21. Specifically, ECU 100 controls the power conversion circuit 50 to be discharged from the battery 21 in S121 until SOC of the battery 21 becomes 0% or less. The discharged electric power may be consumed by an electric power load (not shown) included in the in-vehicle device 60 or may be stored in an auxiliary battery (not shown).

The second equalization process is the aforementioned low voltage charging, that is, the external charging of the battery 21 at the first equalization voltage (see S12 of FIG. 3). That is, in S122, the charge control of the battery 21 is executed at a lower voltage than the normal charge (S21).

When the equalization process is completed in any of S121, S122, the process proceeds to S21. Also, when it is determined that S111 is NO, the process proceeds to S21. In S21, ECU 100 performs external charging (plug-in charging) of the battery 21. Subsequently, in S22, ECU 100 determines whether or not to terminate the charging based on whether or not the charging termination condition is satisfied. Since S21, S22 in FIG. 5 is the same as S21, S22 in FIG. 3, the explanation will not be repeated. While the charge termination condition is not satisfied (NO in S22), S21 plug-in charge is continuously executed. When the charge termination condition is satisfied (YES in S22), the process illustrated in FIG. 5 ends.

In the modification, different equalization processing is executed for each section of the plateau region classified according to the amount of stored electricity. This makes it possible to more appropriately suppress variations in the amount of electricity storage between the cells. Although the charge control is illustrated in FIG. 5, in the discharge control, a different equalization process may be executed for each section of the plateau region.

ECU 100 may adjust the temperature of the battery 21 by the thermal management device 22 during the run of the equalization process (S12, S24 of FIG. 3, S342 of FIG. 4, S121, S122 of FIG. 5). ECU 100 may adjust the battery temperature to within a temperature range in which equalization is promoted.

In the above-described embodiment and modification, ECU 100 determines whether or not the state of charge or the state of discharge of the battery 21 corresponds to the plateau region based on SOC of the battery 21 (S11, S23 in FIG. 3, S33 in FIG. 4, and S111 in FIG. 5). However, the present disclosure is not limited thereto, and ECU 100 may determine whether the state of charge or the state of discharge of the battery 21 corresponds to a plateau region by using OCV of the battery 21 in addition to or instead of SOC of the battery 21. ECU 100 may estimate OCV of the battery 21 based on the inter-terminal voltage, the current, and the inner resistance of the battery 21 while continuing to charge the battery 21. Alternatively, ECU 100 may temporarily stop the charge of the battery 21 and actually measure the voltage (OCV) of the battery 21 when no current is flowing. In addition, ECU 100 may consider the voltage of the battery 21 when a minute current is flowing as OCV of the battery 21.

Applications of the all-solid-state battery system are not limited to vehicles. The all-solid-state battery system may be used in applications other than vehicles (e.g., stationary).

The embodiments disclosed herein are to be understood as being exemplary and not to be construed as being limitative of the present disclosure in every respect. The technical scope indicated by the present disclosure is indicated by the claims rather than the description of the above-described embodiments, and is intended to include all modifications within the meaning and scope equivalent to the claims.

What is claimed is:

1. An all-solid-state battery system comprising:
an assembled battery including a plurality of cells connected to each other; and
a control device configured to perform charge control and discharge control on the assembled battery, wherein:
each of the cells is an all-solid-state battery; and
the control device is configured to, in the charge control or the discharge control, perform an equalization process for equalizing power storage amounts of the cells in a plateau region in a relationship between a voltage and a power storage amount of the assembled battery.

2. The all-solid-state battery system according to claim 1, wherein:
each of the cells includes an electrode layer including a silicon clathrate; and
the assembled battery includes the plateau region in at least a part of a range in which a state of charge indicating a ratio of a current power storage amount to a power storage amount in a fully charged state is 0% or more and 30% or less.

3. The all-solid-state battery system according to claim 1, wherein the control device is configured to perform the charge control on the assembled battery at a voltage lower than a reference voltage in the plateau region as the equalization process, and perform the charge control on the assembled battery at the reference voltage after completion of the equalization process.

4. The all-solid-state battery system according to claim 1, wherein the control device is configured to stop charging the assembled battery as the equalization process when the power storage amount of the assembled battery belongs to the plateau region in the charge control, and charge the assembled battery after completion of the equalization process.

5. A vehicle comprising the all-solid-state battery system according to claim 1.
